(19) United States
(12) Patent Application Publication
(10) Pub. No.: US 2024/0266814 A1
(43) Pub. Date: Aug. 8, 2024

(54) Push to Connect Electrical Connector with Integral Release

(71) Applicant: Hubbell Incorporated, Shelton, CT (US)

(72) Inventor: Victor Beristany, Mishawaka, IN (US)

(21) Appl. No.: 18/431,471

(22) Filed: Feb. 2, 2024

Related U.S. Application Data
(60) Provisional application No. 63/442,898, filed on Feb. 2, 2023.

(51) Int. Cl. H02G 3/06; H01R 13/74

(52) U.S. Cl. CPC H02G 3/065; H01R 13/745; H02G 3/0666

(57) ABSTRACT

A conduit receiving port includes a base member configured to receive at least one conduit, a conduit gripping member configured to grip the at least one conduit and a conduit release member operable for selectively releasing the gripping member's grip on the at least one conduit.

### CROSS-REFERENCE TO RELATED APPLICATIONS

This application is based on and claims priority to U.S. Provisional Application Ser. No. 63/442,898 filed Feb. 2, 2023 entitled Push to Connect Electrical Connector with Integral Release, the entire contents of which are herein incorporated by reference.

### TECHNICAL FIELD

The present disclosure relates generally to electrical connectors, and more particularly to push-to-connect electrical connectors with integral release.

### DESCRIPTION OF THE RELATED ART

Commercial and residential buildings often use common electrical components such as electrical outlets and ground fault circuit interrupter (GFCI) outlets for connecting to a 120 v, 240 v or similar wiring in a building. These components are often enclosed in electrical boxes mounted in walls, floors and ceilings. In particular applications and environments, it is often desirable to provide electrical boxes capable of receiving electrical wire conduit such as electrical metallic tubing (EMT), Rigid or polyvinyl chloride (PVC) conduit, etc. Electrical cables may then be routed within the conduit.

Electrical box fittings are generally separate devices that are mounted in a standard casting knockout hole in an electrical box. For example, a standard electrical box may have a simple knockout or plug in an opening that may be removed. A traditional conduit fitting would be a separate device that has a mechanism such as a threaded nut and washer for securing the conduit fitting in the electrical box. Such a traditional conduit fitting generally requires a specialized tool to remove the conduit from the conduit fitting if necessary. This requires the installer to always carry or have on hand access to the specialized tool while on the job should the need arise requiring an installed conduit to be removed from the conduit fitting.

### SUMMARY OF THE INVENTION

The present disclosure relates to conduit receiving connector or port for connecting conduit to an electrical box. According to an illustrative embodiment of the present disclosure, the conduit receiving port is a push to connect conduit receiving port and conduit retention assembly and includes an integral release for releasing the conduit from the conduit receiving port.

In an exemplary embodiment, the conduit receiving port includes a base member configured to receive at least one conduit, a conduit gripping member configured to grip the at least one conduit and a conduit release member operable for selectively releasing the gripping member's grip on the at least one conduit.

In an exemplary embodiment, a conduit receiving port removably attachable to an electrical box is described. The conduit receiving port includes a base member including a plurality of conduit receiving portions, each for receiving and holding a different diameter conduit. A conduit gripping member includes at least one prong for securing at least one of the different diameter conduits received and held in the conduit receiving portions. A conduit release member is selectively operable to displace the at least one prong for selectively releasing the conduit held in the conduit receiving portions.

### BRIEF DESCRIPTION OF THE DRAWINGS

The accompanying drawings illustrate presently preferred embodiments of the present disclosure, and together with the general description given above and the detailed description given below, serve to explain principles of the disclosure. As shown throughout the drawings, like reference numerals designate like or corresponding parts.

FIG. 1 is a perspective view of an exemplary embodiment of a conduit receiving port according to the present disclosure, secured to an exemplary electrical box;

FIG. 2 is an enlarged view of the conduit receiving port according to an illustrative embodiment of the present disclosure removed from the exemplary electrical box;

FIG. 3 is an exploded view of the conduit receiving port according to an illustrative embodiment of the present disclosure;

FIG. 4 is an enlarged view depicting a conduit being introduced to a conduit receiving port according to an illustrative embodiment of the present disclosure;

FIG. 5 is a partial cutaway view of the conduit receiving port according to an illustrative embodiment of the present disclosure in the electrical box and as depicted in FIG. 4, taken along the lines 4-4;

FIG. 6 is a side partial cutaway view of an exemplary embodiment of conduit receiving port according to an illustrative embodiment of the present disclosure;

FIG. 7 is an enlarged view of a portion of the conduit receiving port according to an illustrative embodiment of the present disclosure as depicted in FIG. 6;

FIG. 8 is a cross-sectional view of the conduit receiving port according to an illustrative embodiment of the present disclosure taken along lines 8-8 of FIG. 6;

FIG. 9 is an enlarged view of a conduit receiving port according to an illustrative embodiment of the present disclosure receiving a conduit;

FIG. 10 is a perspective view including a partial cutaway view of the conduit receiving port according to an illustrative embodiment of the present disclosure;

FIG. 11 is an enlarged view of a portion of the cutaway view depicted in FIG. 10;

FIG. 12 is a perspective view including a partial cutaway view of the conduit receiving port according to an illustrative embodiment of the present disclosure;

FIG. 13 is an enlarged view of a portion of the cutaway view depicted in FIG. 12;

FIG. 14 is a perspective view including a partial cutaway view of the conduit receiving port according to an illustrative embodiment of the present disclosure;

FIG. 15 is an enlarged view of a portion of the cutaway view depicted in FIG. 14;

FIG. 16 is an enlarged view depicting a conduit being introduced to a conduit receiving port according to an illustrative embodiment of the present disclosure;

FIG. 17 is a partial cutaway view of the conduit receiving port according to an illustrative embodiment of the present disclosure in the electrical box and as depicted in FIG. 16, taken along the lines 17-17;

FIG. 18 is a side partial cutaway view of an exemplary embodiment of conduit receiving port according to an illustrative embodiment of the present disclosure;

FIG. 19 is an enlarged view of a portion of the conduit receiving port according to an illustrative embodiment of the present disclosure as depicted in FIG. 18;

FIG. 20 is a cross-sectional view of the conduit receiving port according to an illustrative embodiment of the present disclosure taken along lines 20-20 of FIG. 18;

FIG. 21 is an enlarged view of a conduit receiving port receiving according to an illustrative embodiment of the present disclosure receiving a conduit;

FIG. 22 is a perspective view including a partial cutaway view of the conduit receiving port according to an illustrative embodiment of the present disclosure;

FIG. 23 is an enlarged view of a portion of the cutaway view depicted in FIG. 22;

FIG. 24 is a perspective view including a partial cutaway view of the conduit receiving port according to an illustrative embodiment of the present disclosure;

FIG. 25 is an enlarged view of a portion of the cutaway view depicted in FIG. 24;

FIG. 26 is a perspective view including a partial cutaway view of the conduit receiving port according to an illustrative embodiment of the present disclosure; and

FIG. 27 is an enlarged view of a portion of the cutaway view depicted in FIG. 26.

### DETAILED DESCRIPTION

Various types of electrical boxes are available and are capable of accepting electrical wiring and/or electrical devices such as switches, receptacles, circuit interrupting receptacles, fuses (e.g., fuse boxes or panels) light fixtures, and other electrical devices. As known in the art, electrical boxes may be formed from any number of materials suitable for a particular application and/or environment. The electrical boxes may be formed from various types of materials including, for example, metals such as stainless steel, aluminum, and carbon or “mild” steel, thermoplastics include polycarbonates, polyester, ABS, PVC, etc, fiberglass, etc. The term “electrical box or boxes” as used herein refers broadly to any type of structure meant to house wiring and/or electrical devices.

The present disclosure describes exemplary embodiments of conduit receiving ports for use with electrical boxes. The conduit receiving ports include integral or built-in push to connect type conduit retention assemblies that can accept multiple electrical conduit sizes and that include an integral or built-in conduit release member.

According to illustrative embodiments of the present disclosure, the conduit receiving ports may be formed from one or more of the same or similar materials to that used in the manufacture of electrical boxes. Of course, it will be appreciated the material forming at least the portions of the conduit receiving ports contacting the electrical box should be made of a material or materials that will not react negatively (e.g., galvanic reaction) with the material or materials forming the electrical box and the conduit.

Often, for ease of wire routing between electrical boxes and to protect the electrical wiring, particularly in commercial applications, conduits may be run between electrical boxes. The electrical wiring is then fed between electrical boxes through the conduit. Various types of conduit exist including, but not limited to, for example, Electrical Metallic Conduit (EMT), Flexible Metal Conduit (FMT), Liquid-tight Flexible Metal Conduit (LFMC), Non-metallic Liquid Tight Flexible Conduit, Rigid Metal Conduit (RMC) and Intermediate Metal Conduit (IMT), Electrical Non-metallic Tubing (ENT), PVC, etc. The push to connect connect conduit receiving ports described herein reduce supply costs. For example, since each conduit receiving port is capable of receiving and securing multiple sized conduits, fewer types of conduit receiving ports need to be provided on site. This can also reduce labor costs since the installer is not required to carry or look for an appropriately sized conduit receiving port for each installation and is not required to carry or look for one or more specialized tools required to release the conduit from the conduit receiving port should the need arise. The electrical boxes described herein may also be referred to herein as the “boxes” in the plural and the “box” in the singular. The push to connect type conduit receiving ports described herein may also be referred to herein as the “conduit receiving ports” in the plural and the “conduit receiving port” in the singular. The electrical conduit may also be referred to herein as the “conduits” in the plural and the “conduit” in the singular.

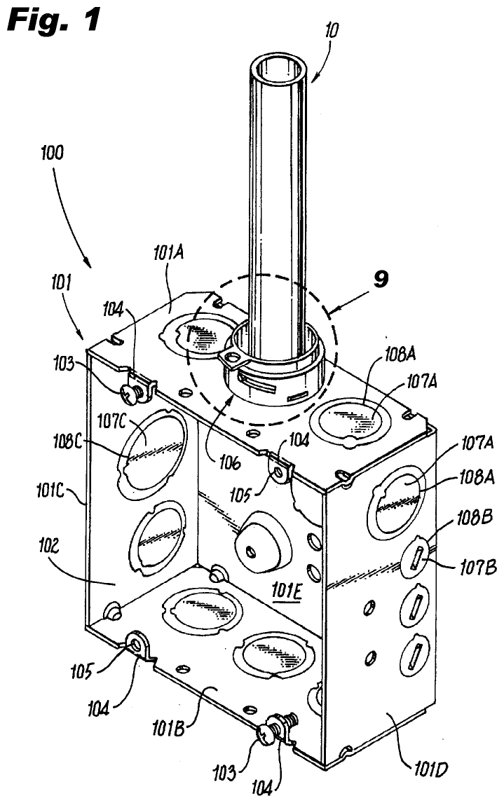

The push-fit type conduit receiving ports described according to illustrative embodiments of the present disclosure may be attached to any suitable type of electrical box, an example of which is shown in FIG. 1 and is referred to herein as electrical box or just box 100. Electrical box 100 may be any suitable type of electrical box capable of receiving and holding electrical wires. In this exemplary embodiment, the box 100 is a 2-gang electrical box and includes a housing 101, one or more supports 104 and generally includes a plurality of openings referred to herein generally as knock-out openings 108 capable of receiving clamps or conduit fittings. The knock-out openings 108 may be the same shape and size or of varying shapes and sizes for receiving clamps or conduit fittings of different shapes and sizes. For example, the electrical box 100 depicted in FIG. 1 may include medium 108A, small 108B and large 108C knock-out openings. The knock-out openings 108 may be covered by removable covers or “knock-outs” 107A, 107B, 107C that may be selectively removed by the end user. The housing 101 has a top wall 101a, a bottom wall 101b, a first side wall 101c, a second side wall 101d and a rear wall 101e that define a device opening 102. The supports 104 are integrally formed around the device opening 102 of box 100 at suitable positions. In the embodiment shown, each support 104 includes an opening 105 capable of receiving a fastener, for example a set screw 103, used to secure an electrical device and/or faceplate to the housing 101.

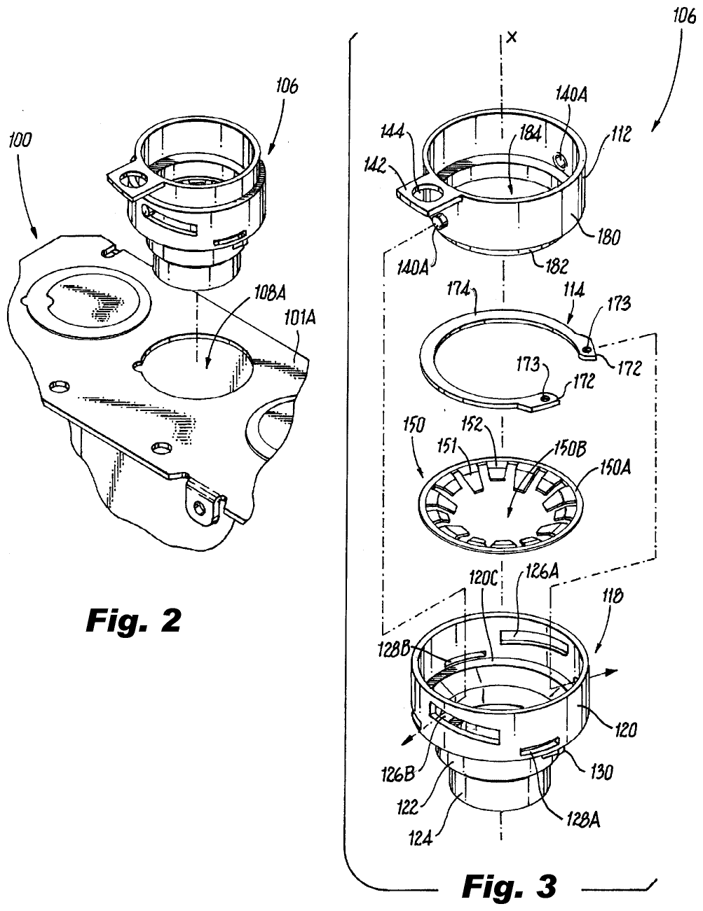

Exemplary embodiments of the present disclosure allow the end user (e.g., electrician or other installer) to configure the electrical box 100 by selective placement of one or more conduit receiving ports 106 in the electrical box so that the box may be configured for a particular application. As shown in FIGS. 1 and 2 by way of example, a conduit receiving port 106 according to an illustrative embodiment of the present disclosure is attached within a knockout opening 108A provided in the middle portion of the top wall 101A of housing 101 of electrical box 100.

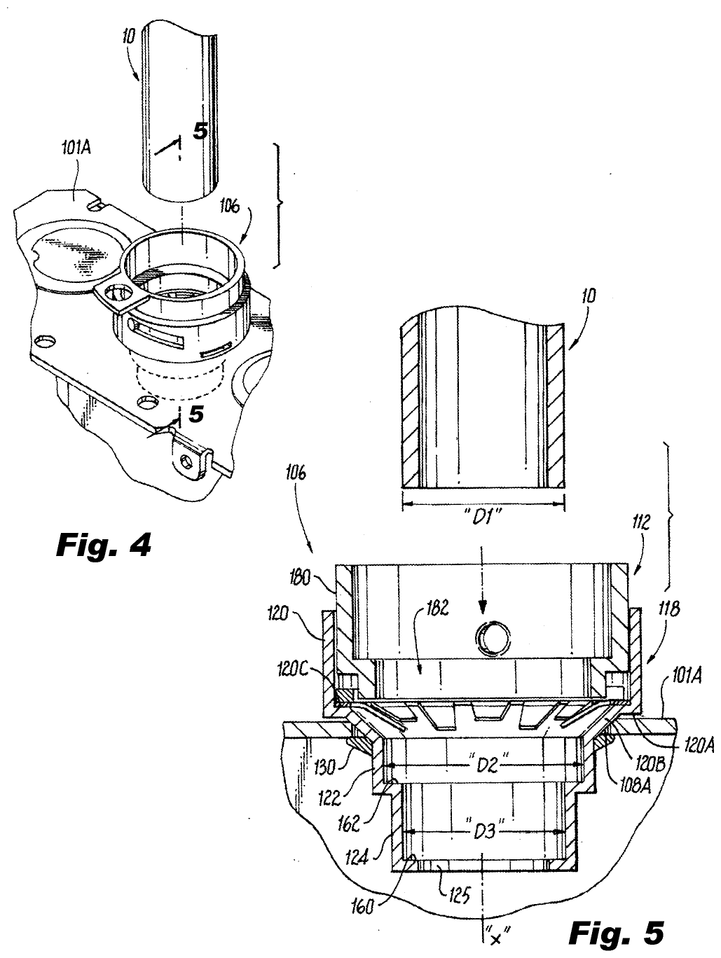

As shown in FIGS. 3-5, conduit receiving port 106 includes a base 118, a conduit gripping member 150, a spring clip or retaining ring 114 and a release member 112. Base 118 includes a plurality of ring-like structures including first ring 120, second ring 122 and third ring 124. According to other embodiments, only second ring 122 is provided. According to other embodiments, other additional rings may be provided in addition to second ring 122 and third ring 124. The outside diameter of first ring 120 is larger than an inside diameter of the knockout opening in which it is intended to rest (e.g., knockout opening 108A) and may include an annular tapered diameter reducing section 120B extending to second ring 122 (FIG. 5). The annular tapered diameter reducing section 120B ensures a secure fit within various diameter knockout openings. The outside diameters of second ring 122 and third ring 124 are smaller than an inside diameter of the knockout opening 108A in which reducing section 120B rests. That is, second ring 122 and third ring 124 have outside diameters dimensioned so that the second ring 122 and third ring 124 of base 118 can pass through knockout opening 108A. As will be appreciated from the following description, the outside diameters of the second ring 122 and third ring 124 (and additional rings if provided) may be the same diameter or different diameter so long as they may pass through knockout opening 108A. Base 118 includes a mechanism for attaching conduit receiving port 106 to the electrical box. For example, according to the illustrative embodiment as shown in FIG. 5, one or more clips 130 are provided extending around the outer circumference of first ring 120 below reducing section 120B. Clips 130 are flexible so that when base 118 of conduit receiving port 106 is inserted and pressed into knockout opening 108A, clips 130 bend slightly until base 118 is fully seated (e.g., see FIG. 5) and clips 130 effectively clip conduit receiving port 106 within knockout opening 108A. According to another embodiment, the outer circumference of ring 122 may be threaded. After base 118 of conduit receiving port 106 is inserted into knockout opening 108A, a threaded ring (not shown) having an outside diameter larger than the diameter of knockout opening 108A may be screwed onto threaded ring 122 and tightened to secure the conduit receiving port 106 to electrical box 100. A lock washer (not shown) may be provided as deemed appropriate. Of course, any other suitable mechanisms for attaching the conduit receiving port 106 to electrical box 100 are contemplated. The inside diameter “D2” of second ring 122 is dimensioned to receive a conduit having a first outside diameter. The inside diameter “D3” of third ring 124 is dimensioned to receive a conduit having a second outside diameter smaller than the first outside diameter. As noted above, additional rings may be provided. For example, another ring having an inside diameter dimensioned to receive a conduit having an outside diameter having a diameter smaller than the second outside diameter may be provided below ring 124.

Conduit 10 is an example of a conduit capable of being received in base 118. Non-limiting examples of the sizes of conduit that may be received in base 118 are as follows. For example, the conduit 10 may be a ¾-inch conduit with an outer diameter “D1” of about 0.875 inches. Alternatively, the conduit 10 may be a ½-inch conduit with an outer diameter “D1” of about 1.125 inches. The conduit 10 may be a 1-inch conduit with an outer diameter “D1” of about 1.375 inches. Of course, the sizes described herein are merely exemplary and rings 122, 124 may have inner diameters different than that described herein and may depend on the type and/or manufacture of the conduit being utilized. According to the illustrative embodiment depicted in FIG. 5, the inside diameter “D3” of ring 124 is dimensioned to receive conduit 10. That is, the inside diameter “D3” of ring 124 is the same or slightly larger than the outside diameter “D1” of conduit 10. For example, assuming conduit 10 is a ¾-inch conduit with an outer diameter “D1” of about 0.875 inches, the inner diameter “D3” of ring 124 might be between about 0.88-0.90 inches to accommodate the ¾-inch conduit having the outside diameter of about 0.875 inches to provide a snug secure fit. In this case, the diameter “D2” of ring 122 might then be dimensioned to receive the larger 1-inch diameter conduit. The bottom of third ring 124 has a ledge or lip 160 extending around the inside periphery of ring 124 upon which the conduit will sit when inserted into ring 124. That is, ledge or lip 160 acts as a stop so that when a conduit with a smaller outer diameter is inserted into the conduit receiving port 206, the end of the conduit can rest on the ledge or lip 160. An orifice 125 extends through the bottom of ring 124 allowing wiring to pass through from conduit 10 into electrical box 100. Similarly, ring 122 includes a ledge or lip 162 extending around the inside periphery of ring 122 upon which the larger diameter conduit will sit when inserted into ring 122. That is, the ledge or lip 162 acts as a stop so that when a conduit with a larger outer diameter is inserted into the conduit receiving port 106, the distal end of the conduit can rest on the ledge or lip 162.

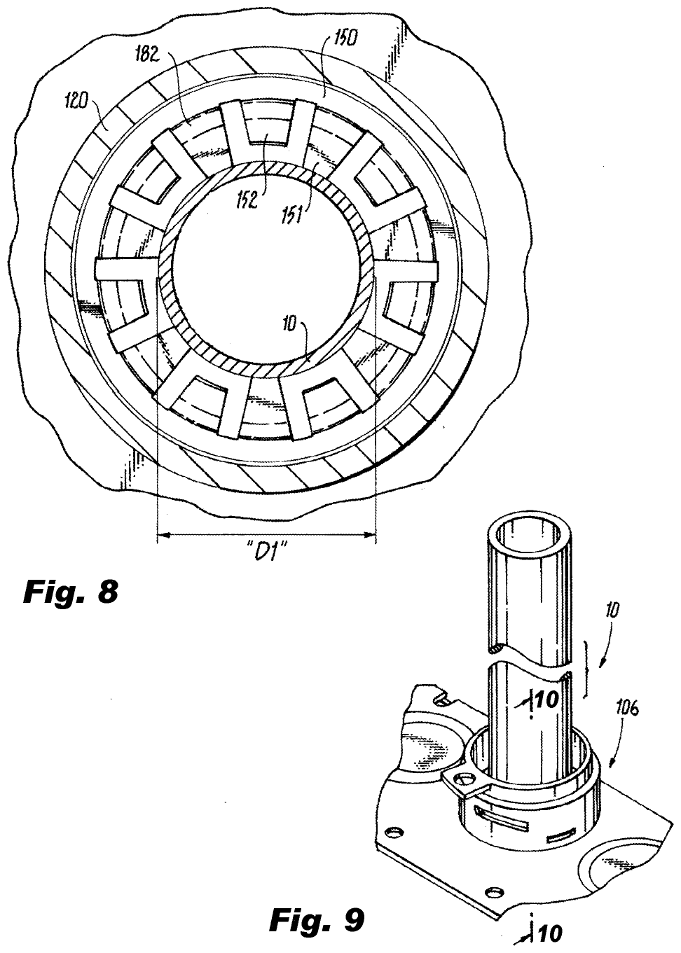

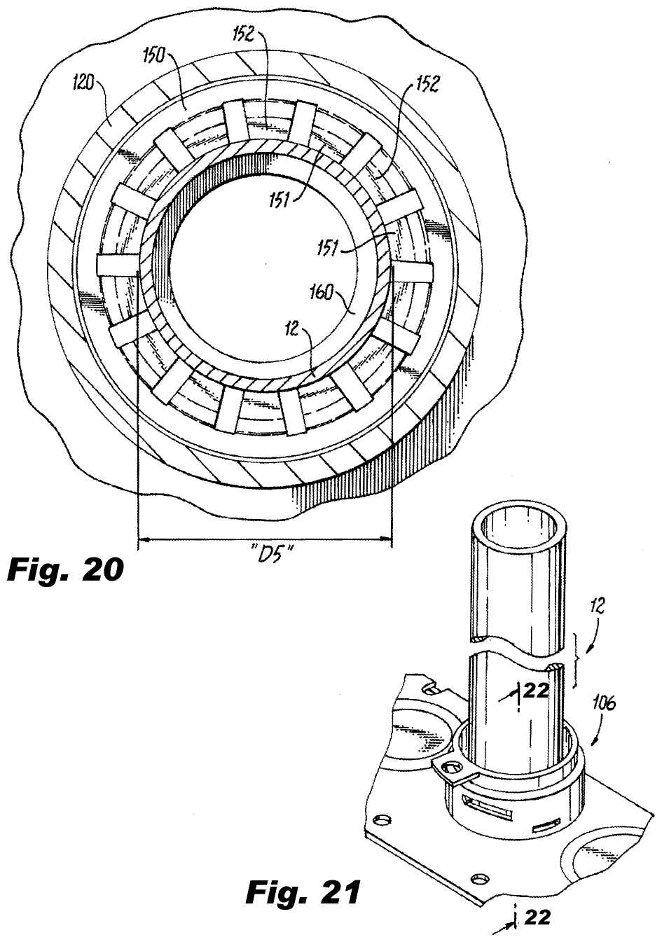

Returning to FIG. 3, upper ring 120 of base 118 includes a lower inside ledge or lip 120C which extends around the inner periphery of the inside of upper ring 120. The conduit gripping member 150 includes a circular outer ring or rim 150A with an open central portion 150B. The outer rim 150A of conduit gripping member 150 is dimensioned such that it rests on the lower inside ledge or lip 120C of upper ring 120. The conduit gripping member 150 is formed from a rigid material, such as steel. Preferably, the conduit gripping member 150 is formed from spring steel such as, for example, 1050 annealed spring steel that may be zinc plated. The open central portion 150B is configured and dimensioned to receive and grip various sized conduits. For example, in the exemplary embodiment shown, the conduit gripping member 150 is a spring-like structure that includes two sets of teeth or prongs 151, 152 of varying lengths and which extend inward from the outer circular rim 150A toward the open central portion 150B. While two sets of teeth or prongs 151, 152 are shown, it will be appreciated only one set or three or more sets may be provided and each set may include one or more teeth or prongs. According to the present illustrative embodiment, the set of teeth or prongs 151 are dimensioned to receive and secure a conduit having a first outer diameter (D1) (e.g., see FIG. 8). The set of teeth or prongs 152 are dimensioned to receive and secure a conduit having a second outer diameter (D5) (e.g., see FIG. 20) which is larger than the first outer diameter. As will be appreciated from FIG. 20, both sets of teeth or prongs 151 and 152 will provide gripping force for the larger diameter (D5) conduit. According to this exemplary embodiment, the conduit gripping member 150 may include a first set of teeth or prongs 151 having a length in a range of between about 0.100 inches and about 0.375 inches, and a second set of teeth or prongs 152 having a length in a range of between about 0.050 inches and about 0.250 inches. According to this illustrative embodiment, the teeth or prongs 151 and 152 extend inwardly toward the hollow central portion 150B and downwardly from an inner periphery of the ring 150A as shown in FIG. 5. The downward angle of the teeth 151 and 152 from the inner periphery of the rim 150A may be in the range of about 10 degrees and about 70 degrees. Of course, the teeth or prongs 151, 152 may be dimensioned and shaped differently to that shown as long as the teeth or prongs 151, 152 are suitable to grip and hold a conduit within the conduit receiving port 106. The one or more sets of teeth or prongs 151, 152 are thus capable of engaging and securing conduits with varying outer diameters within the conduit receiving port 106.

Returning to FIGS. 3-5, spring clip or retaining ring 114 is dimensioned for securing conduit gripping member 150 within base 118. In particular, according to an illustrative embodiment of the present disclosure, retaining ring secures conduit gripping member 150 against the lower inside ledge or lip 120C of upper ring 120 of base 118. Retaining ring 114 is substantially C-shaped having an opening defined by end portions 172. Retaining ring 114 has an outside diameter such that the end portions 172 extend through slotted orifices 128A (only one of which is shown in FIG. 3) in the side wall 118 of ring 120 of base 118. The diametrically opposed portions of retaining ring 114 (e.g., portions 174) extend into slotted orifices 128B (only one of which is shown) provided in the diametrically opposed side wall 118 of ring 120 of base 118. Once conduit gripping member 150 is inserted and positioned on lip or ledge 120C of base 120, retaining ring 114 is inserted such that portions 174 are received in slotted orifices 128B. The end portions 172 of retaining ring 114 are then squeezed together using for example the holes 173 provided in the end portions 172 and a tool designed for such use. The end portions 172 are then lowered into ring 120 so that the lower surface of retaining ring 114 is adjacent or abuts the upper outer circumference surface or rim 150A of conduit gripping member 150. When the end portions 172 are then released, the end portions 172 spring out and are received in slotted orifices 128A, locking retaining ring 114 and conduit gripping member 150 in place. It will be appreciated there may be a gap between the lower surface of retaining ring 114 and the upper outer circumference or rim 150A of conduit gripping member 150 without adversely affecting the functionality of the conduit gripping member 150.

Continuing to refer to FIGS. 3-5, the release member 112 is a circular ring having an upper ring portion 180 and a lower ring portion 182 and an opening 184. The opening 184 in the release member 112 has a diameter sufficient to permit conduits of various sizes (e.g., ½-inch and/or ¾-inch and/or 1-inch diameter conduits) to pass therethrough. The upper ring portion 180 of release member 112 has an outer diameter dimensioned to fit snugly within ring 120 of base 118 and yet is capable of rotating about axis “X” within ring 120. The upper ring portion 180 of release member 112 includes an arm 142 extending from an upper edge thereof and which may include an orifice 144. Orifice 144 is dimensioned to receive a tool (e.g., a screwdriver) that may be used as an aid in rotating release member 112. The lower surface of lower ring portion 182 of release member 112 rests on or adjacent to the top surface of the one or more teeth or prongs 151, 152 of conduit gripping member 150 (e.g., see FIG. 5). Base 118 includes one or more slotted tracks 126B (e.g., see FIG. 3) provided in diametrically opposed side walls of ring 120. According to the present illustrative embodiment, each slotted track 126B is formed in the shape of a diagonal or helical slot. Release member 112 includes a plurality of pins 140A extending outwardly from the side walls of upper ring portion 180. Each pin 140A extending from release member 112 is positioned and dimensioned to correspond to and fit within one of the slotted tracks 126B in base 118. To aid in the assembly process of the conduit receiving port 106, release member 112 may include a plurality of holes in the positions where pins 140A are to be located. Upon assembly, and after release member 112 is inserted into base 118, pins 140A may be inserted through slotted tracks 126B and into the holes in release member 112. The pins may be held in place within the holes in release member 112 in any known manner including, for example, by welds, snap fit, friction fit or by providing corresponding threaded surfaces on portions of pins 140A and the inner surfaces of the holes in release member 112. When assembled, each pin 140A extending from release member 112 thus rests within a corresponding slotted track 126B of ring 120 of base 118. The pins 140A interact with the slotted tracks 126B such that as the release member 112 is rotated in a clockwise or counterclockwise direction (viewed from above) with respect to base 118, the release member 112 moves up or down, respectively, in a vertical direction relative to the base 118 as well as the one or more teeth or prongs 151, 152 of conduit gripping member 150.

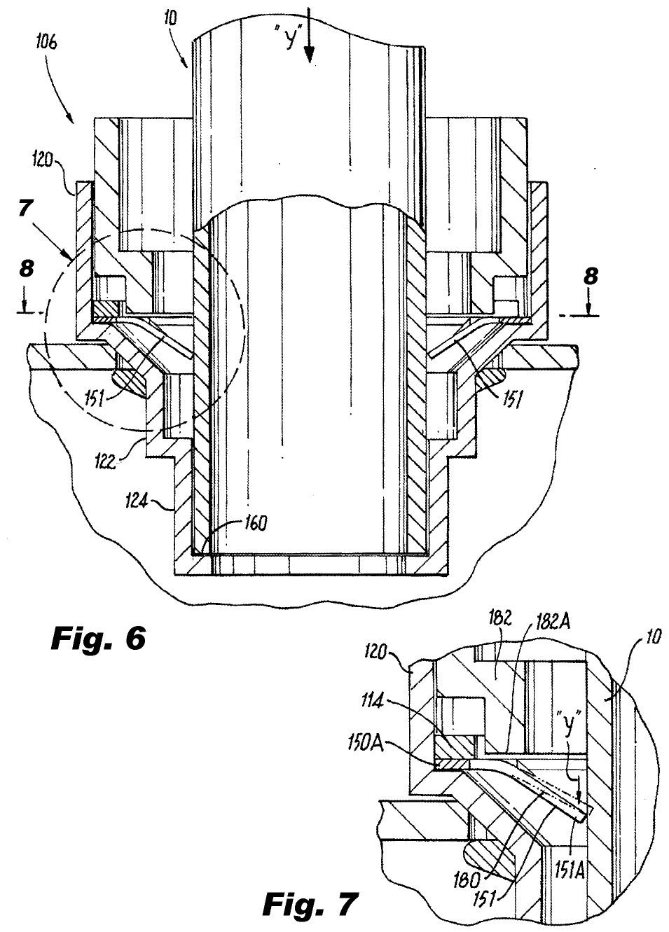

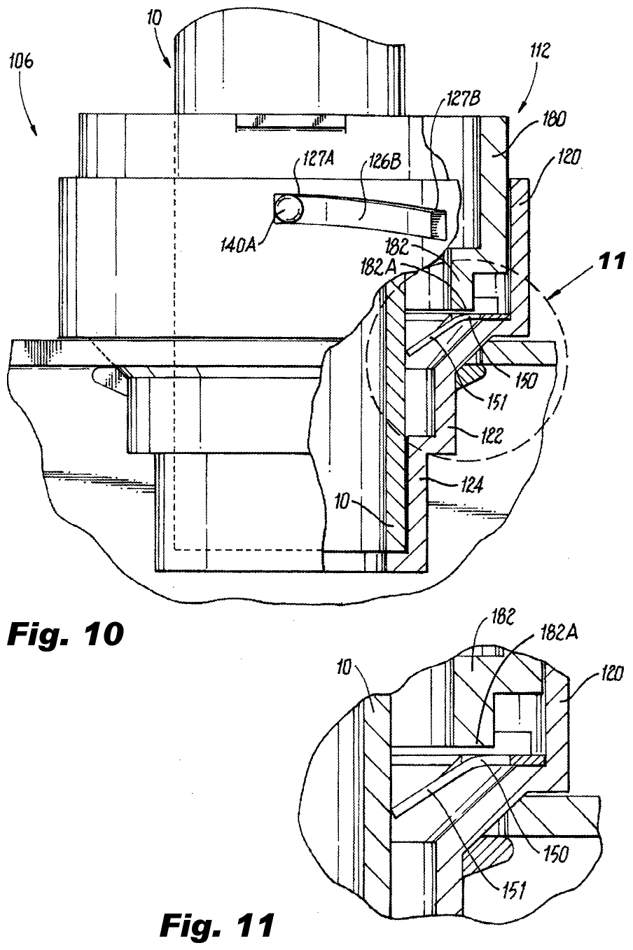

To insert a conduit into conduit receiving port 106, release member 112 is rotated in a clockwise direction (viewed from above) with respect to base 118, raising release member 112 within ring 120 to its uppermost point. In this position, pins 140A extending from the upper portion 180 of release member 112 rest in the uppermost portion 127A of slotted track 126B of base 118 (e.g., see FIG. 10). Conduit 10 may then be inserted in direction “Y” (FIG. 6) into conduit receiving port 106. As conduit 10 is being inserted into conduit receiving port 106 in direction “Y”, the outside walls of conduit 10 urge the teeth or prongs 151 extending from conduit gripping member 150 downward in direction “y” (e.g., see FIG. 7). Conduit 10 is continued to be urged downward in direction “Y” until the bottom or distal end of the conduit 10 rests on ledge or lip 160 extending from ring 124 (e.g., see FIG. 6). As shown in FIG. 7, in this position, prongs 151 press against the outside surfaces of conduit 10 retaining conduit 10 within the conduit receiving port 106.

FIGS. 10 and 11 depict conduit 10 fully seated in conduit receiving port 106. As noted above, in this position, pins 140A extending from the upper portion 180 of release member 112 rest in the uppermost portion 127A of the diagonal or helical slotted track 126B and release member 112 is in its uppermost position. In this position, the lower edge 182A of lower portion 182 of release member 112 is not in contact with the conduit gripping member 150, as shown in FIG. 11. Prongs 151 effectively bite into the sides of conduit 10 preventing conduit 10 from being removed from conduit receiving port 106.

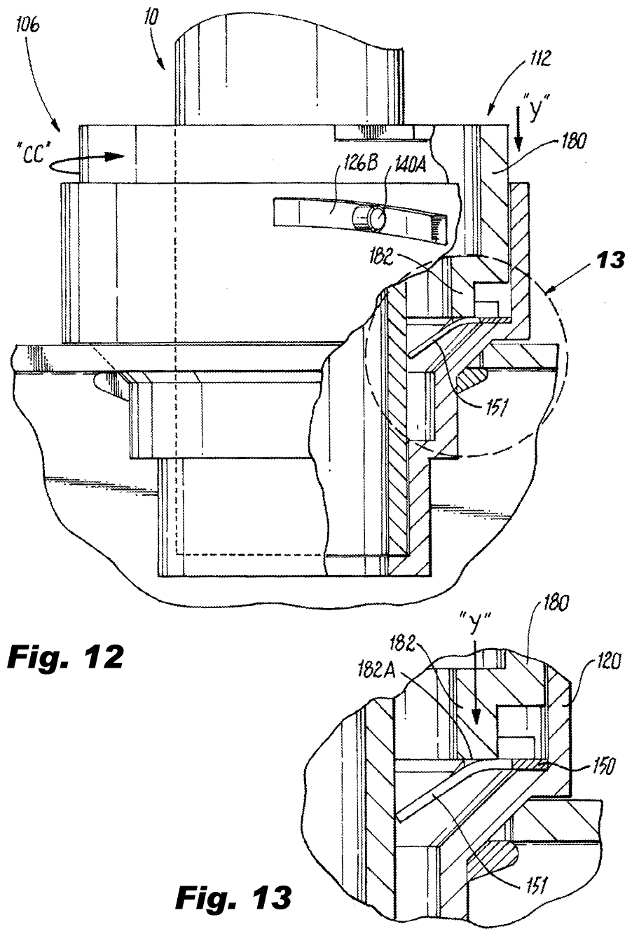

FIGS. 12 and 13 depict release member 112 being rotated in a counter-clockwise direction “CC” (when viewed from above) relative to base 118 to release conduit 10 from conduit receiving port 106. As release member 112 is rotated, pins 140A extending from the upper portion 180 of release member 112 and positioned in the diagonal or helical slotted tracks 126B of base 120 urge release member 112 downward in the “Y” direction until the lower edge 182A of lower portion 182 of release member 112 makes contact with the teeth 151, 152 of the conduit gripping member 150, as shown in FIG. 13.

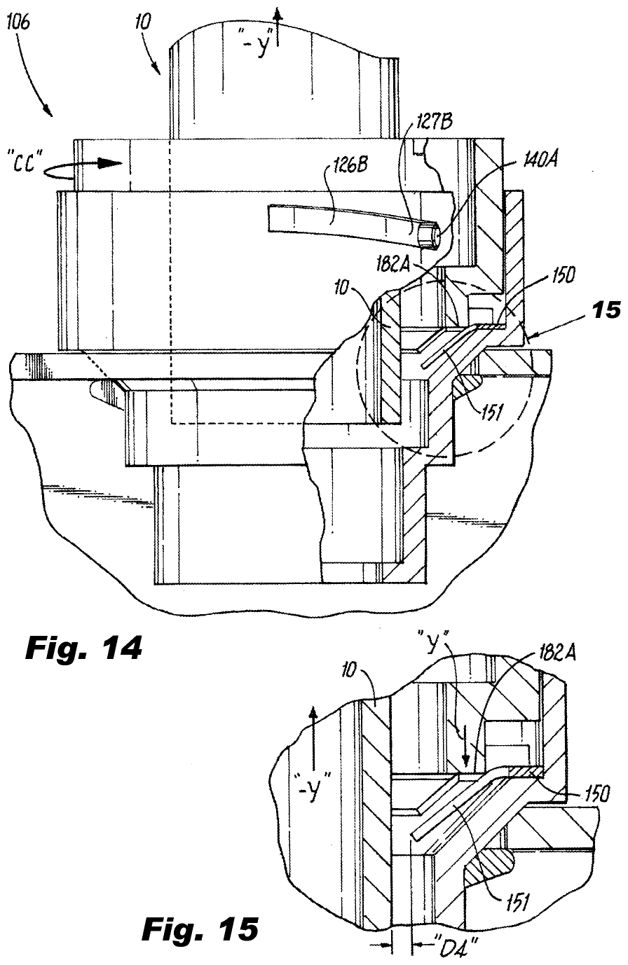

As depicted in FIGS. 14 and 15, as release member 112 continues to be rotated in the counter-clockwise direction “CC”, release member 112 continues to be urged downward in the “Y” direction until pins 140A “bottom out” in the lower ends 127B of diagonal or helical slotted tracks 126B. In this position, the lower edge 182A of lower portion 182 of release member 112 further presses downward on the prongs or teeth 151, 152 of conduit gripping member 150 effectively moving the prongs or teeth 151 out of contact with the sides of conduit 10 and releasing the conduit 10 (e.g., see FIG. 15, gap “D4”). In this position, conduit 10 is released and can be easily removed from the conduit receiving port 106 by pulling it in the “−Y” direction.

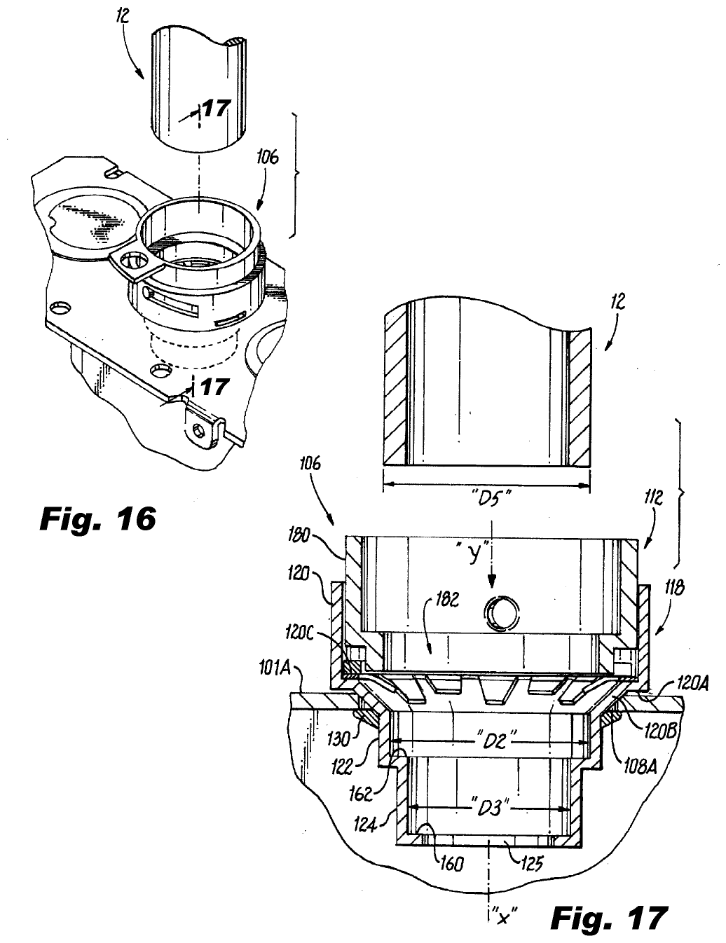

A conduit 12 having a diameter larger than conduit 10 is depicted being inserted and removed from conduit receiving port 106 according to an embodiment of the present disclosure in FIGS. 16-27. As shown in FIG. 17, conduit 12 has a diameter “D5” which is larger than the diameter “D1” of conduit 10. According to the present illustrative embodiment, upper ring 122 of base 118 has a diameter “D2” and is dimensioned to receive conduit 12 such that the lower or distal end of conduit 12 rests on ledge 162.

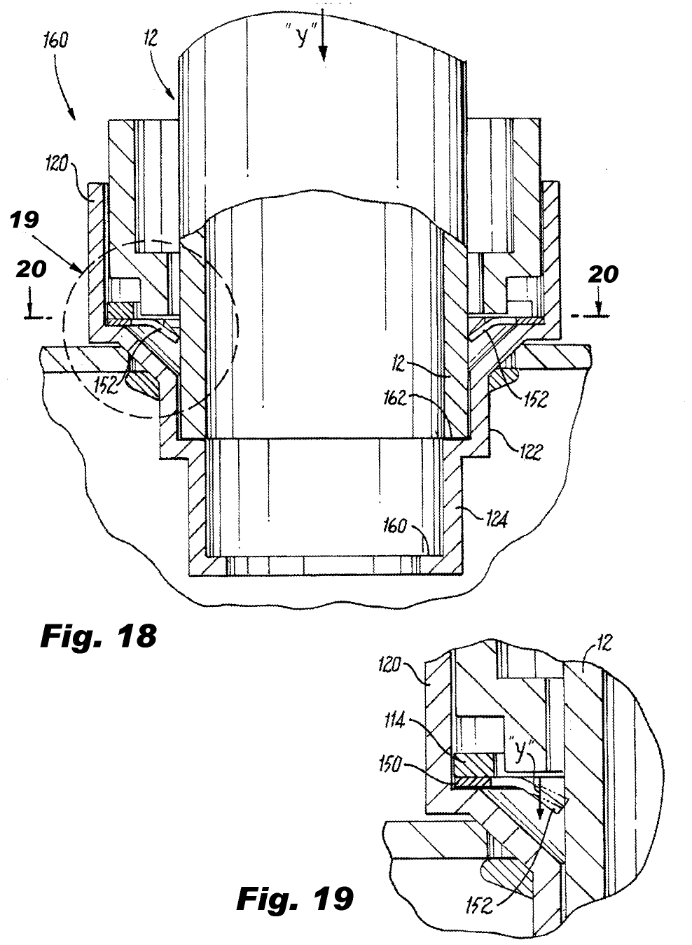

To insert conduit 12 into conduit receiving port 106, release member 112 is rotated in a clockwise direction (viewed from above) with respect to base 118, raising release member 112 within ring 120 to its uppermost point. In this position, pins 140A extending from the upper portion 180 of release member 112 rest in the uppermost portion 127A of slotted track 126B of base 118 (e.g., see FIG. 18). Conduit 12 is then inserted in direction “Y” (FIG. 18) into conduit receiving port 106. As conduit 12 is being inserted into conduit receiving port 106 in direction “Y”, the outside walls of conduit 12 urge the teeth or prongs 152 (and prongs 151) extending from conduit gripping member 150 downward in direction “Y” (e.g., see FIG. 19). Conduit 12 is continued to be urged downward in direction “Y” until the bottom or distal end of the conduit 12 rests on ledge or lip 162 extending from ring 122 (e.g., see FIG. 18). As shown in FIGS. 19 and 20, in this position, prongs 152 (and prongs 151) press against the outside surfaces of conduit 12 retaining conduit 12 within the conduit receiving port 106.

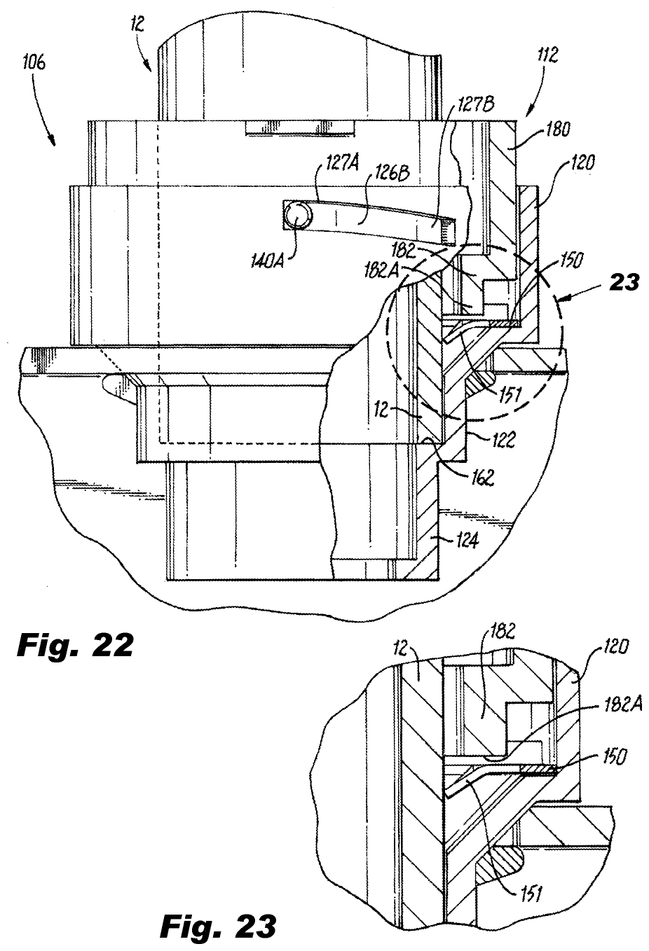

FIGS. 21-23 depict conduit 12 fully seated in conduit receiving port 106. In this position, as noted above, pins 140A extending from the upper portion 180 of release member 112 rest in the uppermost portion 127A of the diagonal or helical slotted track 126B and release member 112 is in its uppermost position (FIG. 22). In this position, the lower edge 182A of lower portion 182 of release member 112 is not in contact with the conduit gripping member 150, as shown in FIG. 23. Accordingly, prongs 151 and 152 effectively bite into the sides of conduit 12 preventing conduit 12 from being removed from conduit receiving port 106.

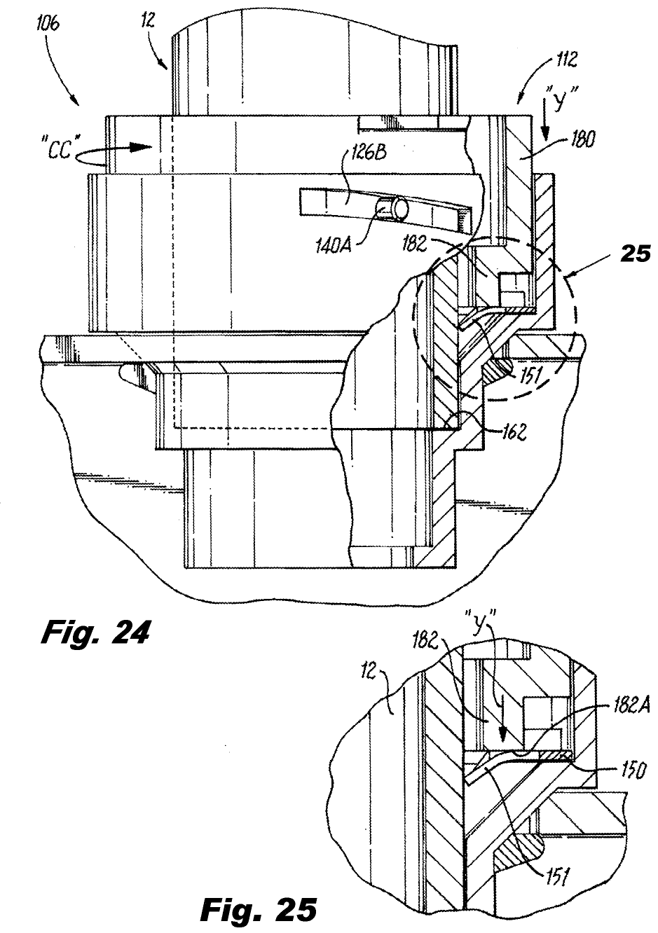

FIGS. 24 and 25 depict release member 112 being rotated in a counter-clockwise direction “CC” (when viewed from above) relative to base 118 to release conduit 12 from conduit receiving port 106. Pins 140A extending from the upper portion 180 of release member 112 and positioned in the diagonal or helical slotted tracks 126B urge release member 112 downward in the “Y” direction until the lower edge 182A of lower portion 182 of release member 112 makes contact with the teeth 151, 152 of the conduit gripping member 150, as shown in FIG. 25.

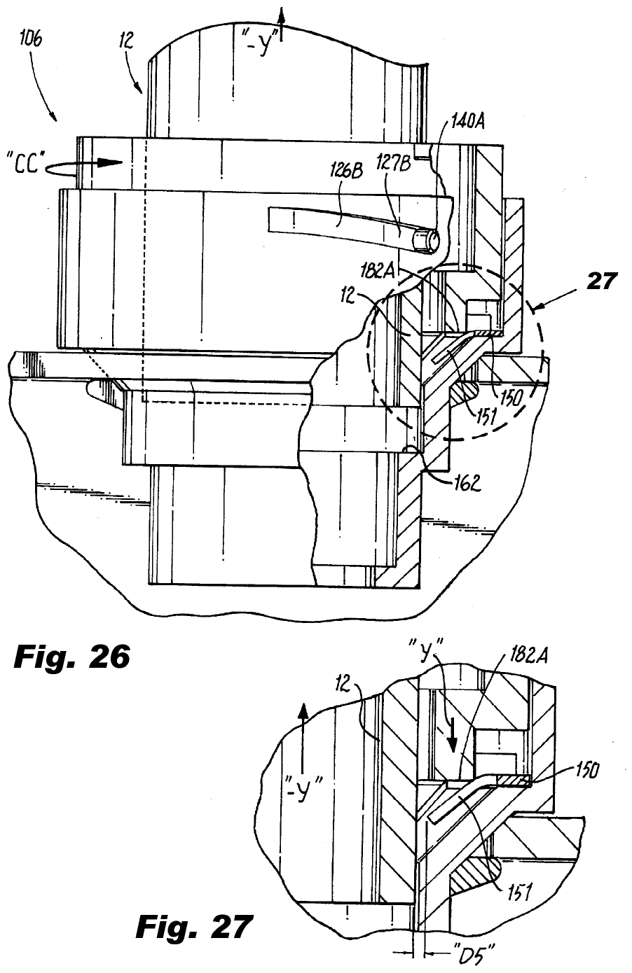

As depicted in FIGS. 26 and 27, as release member 112 continues to be rotated in the counter-clockwise direction “CC”, release member 112 continues to be urged downward in the “Y” direction until pins 140A “bottom out” in the lower ends 127B of diagonal or helical slotted tracks 126B. In this position, the lower edge 182A of lower portion 182 of release member presses further downward on the prongs or teeth 151, 152 of conduit gripping member 150 effectively moving the prongs or teeth 151, 152 out of contact with the sides of conduit 12 and releasing the conduit 12 (e.g., see gap “D5”). In this position, conduit 12 is released and can be easily removed from the conduit receiving port 106 by pulling it in the “−Y” direction.

One or more of the exemplary embodiments of the present disclosure describe a conduit receiving port having a push-to-connect style fitting and release built directly into the conduit receiving port. The conduit receiving port is capable of receiving one or more differently dimensioned conduits. For an installation process using such devices, the user will simply mount the conduit receiving port to a conventional electrical box and push in the conduit such as PVC, EMT or Rigid conduit into the port and a metal retainer ring will bite into the conduit locking it into the conduit receiving port. With a simple twist of a release ring, the conduit can be released and removed from the conduit receiving port without the need for any specialized tools or training. These new methods, configurations and fittings reduce the need for specialized tools and drastically reduce the labor required to install the conduit to the box and allow easy removal of conduits from the port.

In certain embodiments, one or more portions of the conduit receiving port may be constructed of steel or cast aluminum. In yet other embodiments, one of many different plastics (PVC, PC) that are traditionally used may be selected or any other material or materials traditionally used to form electrical boxes, including weatherproof electrical boxes, may be used to form one or more portions of the conduit receiving port. While alternative mechanisms described herein may share certain features and/or capabilities, the manufacturing assembly processes may vary.

In certain exemplary embodiments, a removably fixed fitting may be used having an integrated conduit gripping member such as a spring steel ring with teeth and a conduit release member. For such embodiments, a separate tool is not necessary to remove conduits from the box after installation. For example, according to certain exemplary embodiments, the conduit release member is provided integrally in conjunction with the conduit gripping member. The release is moved in a specific direction which causes deflection of the conduit gripping member allowing easy removal of the conduit from the hub. For example, when the conduit release member is moved in a specific direction, the teeth of the conduit gripping device are moved away from the conduit, thus releasing the conduit and allowing the conduit to be easily removed from the box. According to exemplary embodiments, a conduit receiving port including integral conduit retention device and release is formed as a unit capable of being attached to an electrical box in any suitable manner.

While illustrative embodiments of the present disclosure have been described and illustrated above, it should be understood that these are exemplary and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A conduit receiving port comprising:
a base member configured to receive at least one conduit;
a conduit gripping member configured to grip the at least one conduit; and
a conduit release member operable for selectively releasing the gripping member's grip on the at least one conduit.

2. The conduit receiving port as recited in claim 1, wherein the base member is configured to be attached to an opening of an electrical box.

3. The conduit receiving port as recited in claim 2 wherein at least a portion of the base member is dimensioned to rest against an outside surface surrounding the opening of the electrical box.

4. The conduit receiving port as recited in claim 3, wherein at least a portion of the base member is dimensioned to be received in the electrical box.

5. The conduit receiving port as recited in claim 1, wherein the base member comprises a plurality of rings each having a different inner diameter and each for receiving a conduit having a different outer diameter.

6. The conduit receiving port as recited in claim 1, further comprising a retaining clip for securing the conduit gripping member in the base member.

7. The conduit receiving port as recited in claim 1, wherein the conduit gripping member comprises at least one prong dimensioned to grip the at least one conduit.

8. The conduit receiving port as recited in claim 7, wherein the conduit release member is rotatable within the base member about a first axis.

9. The conduit receiving port as recited in claim 8, wherein the conduit release member moves up and down along the first axis as the conduit release member is rotated within the base in clockwise and counterclockwise directions about the first axis.

10. The conduit receiving port as recited in claim 9, wherein the conduit release member selectively displaces the at least one prong to release the conduit when the conduit release member is rotated within the base in one of the clockwise and counterclockwise directions.

11. A conduit receiving port removably attachable to an electrical box, the conduit receiving port comprising:
a base member comprising a plurality of conduit receiving portions, each for receiving and holding a different diameter conduit;
a conduit gripping member comprising at least one prong for securing at least one of the different diameter conduits received and held in the conduit receiving portions; and
a conduit release member selectively operable to displace the at least one prong for selectively releasing the conduit held in the conduit receiving portions.

12. The conduit receiving port as recited in claim 11, wherein the base member is configured to be attached to an opening of the electrical box.

13. The conduit receiving port as recited in claim 12 wherein at least a portion of the base member is dimensioned to rest against an outside surface surrounding the opening of the electrical box.

14. The conduit receiving port as recited in claim 13, wherein at least a portion of the base member is dimensioned to be received in the electrical box.

15. The conduit receiving port as recited in claim 11, wherein the plurality of conduit receiving portions comprise a plurality of rings each having a different inner diameter and each for receiving a conduit having a different outer diameter.

16. The conduit receiving port as recited in claim 11, further comprising a retaining clip for securing the conduit gripping member in the base member.

17. The conduit receiving port as recited in claim 11, wherein the at least one prong comprises a plurality of sets of prongs, each of the plurality of sets of prongs being sized differently.

18. The conduit receiving port as recited in claim 11, wherein the conduit release member is rotatable within the base member about a first axis.

19. The conduit receiving port as recited in claim 18, wherein the conduit release member moves up and down along the first axis as the conduit release member is rotated within the base in clockwise and counterclockwise directions about the first axis.

20. The conduit receiving port as recited in claim 19, wherein the conduit release member selectively displaces the at least one prong to release the conduit when the conduit release member is rotated within the base in one of the clockwise and counterclockwise directions.
